(19) United States
(12) Patent Application Publication
(10) Pub. No.: US 2021/0060542 A1
(43) Pub. Date: Mar. 4, 2021

(54) COMPOUND DISPENSING

(71) Applicant: HEWLETT-PACKARD DEVELOPMENT COMPANY, L.P., Spring, TX (US)

(72) Inventors: David OCHS, Corvallis, OR (US); Jeffrey A. NIELSEN, Corvallis, OR (US)

(21) Appl. No.: 16/605,915

(22) PCT Filed: Sep. 27, 2017
(86) PCT No.: PCT/US2017/053799

§ 371 Date: Oct. 17, 2019

(51) Int. Cl. B01L 3/02; B05B 12/14

(52) U.S. Cl. CPC B01L 3/0286; B01L 3/0241; B01L 2300/0829; B05B 12/1418; B01L 3/0289

(57) ABSTRACT

Examples disclosed herein relate to a device. Examples devices include a dispense routine engine to determine a first dispense routine for a first compound in a first chamber and a second compound in a second chamber. The dispense routine engine to determine a second dispense routine for the first compound and the second compound in response to a cancel chamber request for the second chamber and a chamber designation request for the second compound in a third chamber. Example devices include a dispense engine to control the dispense device to cancel dispensing of the second compound from the second chamber and to dispense at least a portion of the first compound from the first chamber and at least a portion of the second compound from the third chamber according to the second dispense routine.

### BACKGROUND

Laboratories often run experiments using various different liquids to obtain different types of experimental data. The experiments may use fluid dispense device that dispense fluid into well plate(s) to perform the various different experiments.

### BRIEF DESCRIPTION OF THE DRAWINGS

The following detailed description references the drawings, wherein:

FIG. 1 is a block diagram of an example device;

FIG. 2 is a block diagram of an example device;

FIG. 3 is a flowchart of an example process;

FIGS. 4A, 4B, and 4C are a flowcharts of example processes which may be incorporated into the flowchart of FIG. 3; and

FIG. 5 is a block diagram of an example device to dispense a compound.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Fluid dispense devices may dispense compounds into a well plate. In examples, the compounds may be housed or stored in chambers accessible to the fluid dispense device for dispensing. Fluid dispense devices may receive a dispense request to control which compounds are dispensed in which location or well of a well plate. The dispense device may generate a dispense routine to perform the dispense request. In some examples, an error may be detected after the dispense routine has been initiated. For example, it may be determined that the wrong compound was loaded in a chamber. In other examples, a compound in a chamber may have become contaminated during the dispense routine. Canceling a dispense routine may result in the loss of precious experimental fluid. However, not all compounds in a dispense routine may be contaminated or erroneously loaded.

In examples and throughout the specification, a “well plate” refers to a physical structure to house compounds, which are also referred to as simply “wells.” In some examples, a well plate may include a commercially available plate with a plurality of wells (e.g., a 384 well plate, a 1534 well plate, etc.), a polymeric sheet with pockets formed therein, a lab-on-chip device, a slide, a material to receive a reaction compound(s) (e.g., a porous material), or any other type of structure to receive a compound(s). In contrast, a well refers to a single physical structure or location on a material to receive a compound(s). In examples, a “well” may be a single well of a commercially available well plate, a single pocket in a polymeric sheet, a single region of a lab-on chip-device, and a single region of a material. In some examples, a lab-on-chip device may include channels and/or chambers which may act as a well. In some examples, a material may be a porous material with regions which may act as a well.

Moreover, as used herein, a “compound” refers to a powder or fluid to be dispensed by a fluid dispense device. In some examples, compounds may be fluids such as aqueous based compounds, aqueous based compounds with surfactants or glycerol added therein, dimethyl sulfoxide (DMSO) based compounds, mixture of compounds (e.g., a master mix), and the like. In other examples, compound may be fluids including nanoparticles, small molecules, or biomolecules (i.e. proteins, enzymes, lipids, antibiotics, DNA samples, cells, or blood components, etc.) added to a base fluid. In yet other examples, a compound may be a solid, such as a powder, of metals, ceramics, or composites to be dispensed by a dispense device.

Furthermore, as used herein, a “dispense request” is a request received by a device to dispense a compound(s) into a particular well. A dispense request may include a request for a concentration or dilution of the compound to be ejected/dispensed. As user herein, a “dispense routine” refers to instructions to actuate a fluid dispense device to eject/dispense a compound according to a dispense request.

To address the issues described herein, in some examples, a device is described in which a dispense routine of a compound may be changed from being associated with a first chamber to a second chamber. In examples, the device may alter the dispense routine associated with a dispense request by associating the second chamber with the compound. In some examples, the device may receive a cancel compound request to cancel ejection/dispensing of a compound from a chamber. In examples, the device may receive an additional chamber designation for the compound in another chamber to allow a dispense request to proceed.

As shown herein, example devices may comprise engines, where such engines may be any combination of hardware and programming to implement the functionalities of the respective engines. In some examples described herein, the combinations of hardware and programming may be implemented in a number of different ways. For example, the programming for the engines may be processor executable instructions stored on a non-transitory machine-readable storage medium and the hardware for the engines may include a processing resource to process and execute those instructions. A “processor” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution of instructions stored on a machine-readable storage medium, or a combination thereof.

In some examples, a device implementing such engines may include the machine-readable storage medium storing the instructions and the processing resource to process the instructions, or the machine-readable storage medium may be separately stored and accessible by the system and the processing resource. In some examples, engines may be implemented in circuitry. Moreover, processing resources used to implement engines may comprise a processor (e.g., a CPU), an application specific integrated circuit (ASIC), a specialized controller, and/or other such types of logical components that may be implemented for data processing.

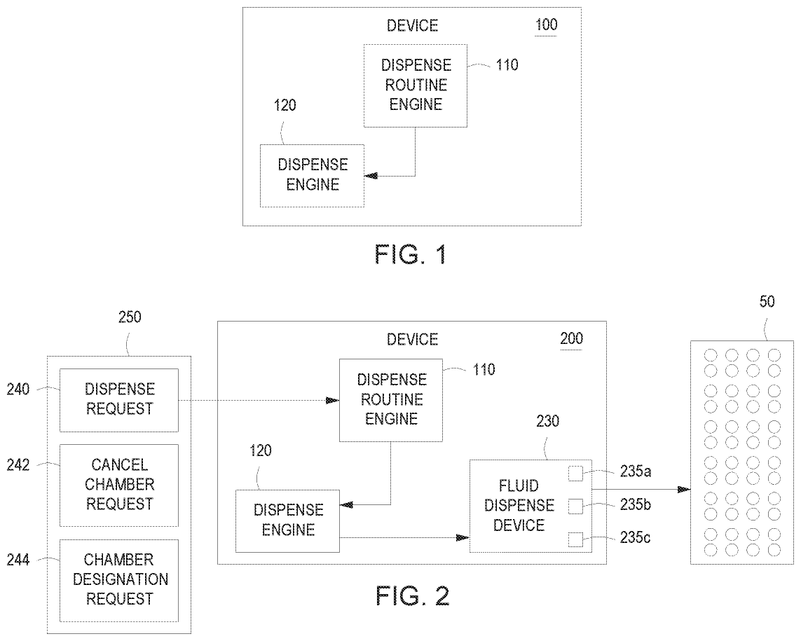

Turning now to the figures, and particularly to FIG. 1, this figure provides a block diagram that illustrates some components of an example device 100. Example device 100 may include a dispense routine engine 110 and a dispense engine 120.

In some examples, device 100 may be a device to control the ejection/dispensation of a fluid. In some examples, device 100 may control ejection of a fluid by a fluid dispense device to dispense or eject a fluid. Example fluid dispense devices may include digital titration devices, pharmaceutical dispensation devices, lab-on-chip devices, fluidic diagnostic circuits, n-based ejection devices (e.g., printheads), 3D printing devices, and/or other such devices in which amounts of compounds may be dispensed or ejected. In examples, fluid dispense devices may include chamber(s) to receive or house a compound to be dispensed/ejected. In such examples, the dispense routine may include instructions to eject/dispense a compound from a specific chamber of the fluid dispense device according to a dispense request.

In examples, dispense routine engine 110 may determine a first dispense routine for a first compound in a first chamber and a second compound in a second chamber. In examples, dispense routine engine 110 may determine a second dispense routine for the first compound and the second compound in response to a cancel chamber request for the second chamber and a chamber designation request for the second compound in a third chamber. In examples, dispense routine engine 110 may determine the second dispense routine by associating the second compound with the third chamber. As used herein, a “cancel compound from chamber request” or “chamber cancel request” refers to instructions received by device 100 to cancel or pause ejection of a specific chamber of a fluid dispense device. In some examples, the chamber cancel request may include identification of the compound to be canceled or paused in addition to a chamber to be canceled/paused. As used herein, a “chamber designation request” refers to instructions to associate a specific chamber of a fluid dispense device with a specific compound. In other words, a “chamber designation request” instructs the fluid dispense device to use a new chamber to perform dispense operations associated with a prior chamber.

In examples, device 100 may passively acquire (i.e., receive) or actively acquire (i.e., retrieve) the dispense request. In examples, a dispense request may be a request to dispense compound(s) from the fluid dispense device. In operation, in an example, device 100 may receive a dispense request identifying compounds in two chambers to be dispensed. In such an example, during execution of a dispense routine associated with the dispense request, an error may be detected with respect to a compound in a first chamber. In such an example, device 100 may receive a chamber cancel request for the first chamber. In examples, device 100 may prompt a user, via a display coupled thereto, to provide the compound in a new chamber. In such an example, a chamber designation request may identify the new chamber housing the compound provided by the user. In examples, dispense routine engine 110 may determine a new dispense routine for the dispense request by associating the new chamber with the first chamber. In some examples, a variety of factors may be considered to determine the dispense routine, such as, volume of any fluid in a well, a well size, volume of compounds to be dispensed remaining in the fluid dispense device, drop volume range of the fluid dispense device, etc.

In some examples, the dispense request, the cancel chamber request, and the chamber designation request may be acquired from a display coupled to device 100 displaying, for example, a graphical user interface (GUI). In other examples, the dispense request, the cancel chamber request, and the chamber designation request may be acquired from a remote device via any communication protocol. In the following discussion and in the claims, the term “couple” or “couples” is intended to include suitable indirect and/or direct connections. Thus, if a first component is described as being coupled to a second component, that coupling may, for example, be: (1) through a direct electrical or mechanical connection, (2) through an indirect electrical or mechanical connection via other devices and connections, (3) through an optical electrical connection, (4) through a wireless electrical connection, and/or (5) another suitable coupling. In contrast, the term “connect,” “connects,” or “connected” is intended to include direct mechanical and/or electrical connections.

By way of example, a device 100 may be coupled to a fluid dispense device including a first chamber that stores a first compound to be dispensed and a second chamber that stores a second compound to be dispensed. In such an example, the fluid dispense device may include a number of other chambers to store compounds. In examples, the fluid dispense device may dispense or eject the first compound and the second compound into a well of a well plate coupled thereto. In examples, dispense engine 120 may control the fluid dispense device to cancel dispensing of a compound from a chamber of the fluid dispense device. For example, dispense engine 120 may control the fluid dispense device to cancel dispensing of the second compound in the second chamber of the fluid dispense device. In such an example, a chamber designation request may identify a third chamber as housing the second compound. In such an example, dispense engine 120 may control the fluid dispense device to dispense at least a portion of a first compound from a first chamber and at least a portion of the second compound from the third chamber according to a dispense routine. In examples, dispense engine 120 may be coupled to the fluid dispense device to dispense fluid into the well plate. In examples, the well plate may be coupled to a transportation mechanism to move or transport the well plate such that a specific well may receive a compound from the fluid dispense device. In other examples, the well plate may remain stationary and the fluid dispense device or a portion thereof, may travel or be transported such that a specific well may receive a compound from the fluid dispense device. In yet further examples, both the well plate and the fluid dispense device may travel or move to allow a well in the well plate to receive a compound from the fluid dispense device.

In examples, the fluid dispense device may include chamber(s) to receive compound(s) to be ejected/dispensed. In examples, the fluid dispense device may dispense/eject a compound(s) from the chamber(s) in any manner. In examples, the fluid dispense device may include a fluid die with nozzles formed therein and an ejection chamber. In examples, nozzles may facilitate ejection/dispensation of a compound. Fluid dispense devices may comprise fluid actuators disposed proximate to the nozzles to cause drops of compound(s) to be ejected/dispensed from a nozzle orifice. In some examples, dispense engine 120 may generate a control pulse to electrically actuate the fluid actuator of the fluid dispense device to thereby dispense the compound(s). Some examples of types of fluid ejectors implemented in fluid dispense devices include thermal ejectors, piezoelectric ejectors, pressure pulse ejectors, acoustic ejectors, syringes, pin transfer tools and/or other such ejectors that may cause compound to eject/be dispensed from a nozzle. In some examples, the chamber(s) of the fluid dispense device may be removable. For example, the chamber(s) may be part of a component of the fluid dispense device which may be removed, such as a pipette or a cassette. In one such example, the fluid die, nozzle, and ejection chamber of the fluid dispense device may be removable from the fluid dispense device. In examples, fluid dispense devices may be able to dispense volumes from approximately 2 pL to approximately 200 μL. In such an example, the fluid dispense devices may dispense or eject a drop with a drop volume between approximately 2 pL and approximately 300 pL per drop.

Turning now to FIG. 2, this figure illustrates a diagram of an example of a fluid device 200. The device 200 may include all features discussed with reference to the examples of FIG. 1. Example device 200 may include a dispense routine engine 210, a dispense engine 220, and a fluid dispense device 230.

In some examples, device 200 may be a device to control the ejection of a fluid. In some examples, device 200 may control ejection of a fluid by fluid dispense device 230 coupled thereto to dispense or eject a fluid. Example fluid dispense device 230 may include digital titration devices, pharmaceutical dispensation devices, lab-on-chip devices, fluidic diagnostic circuits, drop-based ejection devices (e.g., printheads), 3D printing devices, and/or other such devices in which amounts of compound(s) may be dispensed or ejected. In this example, the fluid dispense device 230 is illustrated in dashed line to indicate that the fluid dispense device 230 may removably couple with device 200. While in this example, the fluid dispense device 230 may removably couple with device 200, other examples may include other configurations. For example, portions of the fluid dispense device 230 may be coupled to the device, while some portions may be removably coupled therewith. In examples, fluid dispense device 230 includes a chamber 235a, a chamber 235b, and chamber 235c to receive or house a compound to be dispensed/ejected. In such examples, the dispense routine may include instructions to eject/dispense a compound from a specific chamber of fluid dispense device 230 according to a dispense request 240. In some examples, device 200 may be a fluid dispense device to dispense or eject a fluid into well plate 50. In such an example, device 200 may include a removable fluid ejector, such as a pipette or a fluid die with nozzles. In examples, well plate 50 may be coupled to device 200 to allow device 200 to dispense a compound therein.

In examples, dispense routine engine 210 may determine a first dispense routine for a first compound in chamber 235a and a second compound in chamber 235b according to dispense request 240. In examples, dispense routine engine 210 may determine a second dispense routine for the first compound and the second compound in response to a cancel chamber request 242 for chamber 235b and a chamber designation request 244 for the second compound in chamber 235c. In examples, dispense routine engine 210 may determine the second dispense routine by associating the second compound with chamber 235c.

In examples, device 200 may passively acquire (i.e., receive) or actively acquire (i.e., retrieve) dispense request 240, cancel chamber request 242, and chamber designation request 244. In operation, in an example, device 200 may receive dispense request 240 identifying compounds in chamber 235a and 235b to be dispensed. In such an example, during execution of a dispense routine associated with dispense request 240, an error may be detected with respect to a compound in chamber 235a by a user. For example, the error may be an incorrectly loaded compound in chamber 235a or contamination of the compound in chamber 235a. In such an example, device 200 may receive a chamber cancel request 242 for chamber 235a. In examples, device 200 may prompt a user, via a display 250 coupled thereto, to provide the compound of chamber 235a in a new chamber. In such an example, chamber designation request 244 may identify the new chamber housing the compound as chamber 235c. In examples, dispense routine engine 210 may determine a new dispense routine for dispense request 240 by associating chamber 235c with chamber 235a. In other examples, dispense routine engine 210 may determine the new dispense routine for dispense request 240 by associating chamber 235c with the compound of chamber 235a. In some examples, a variety of factors may be considered to determine the dispense routine, such as, volume of any fluid in a well, a well size, volume of compounds to be dispensed remaining in device 230, drop volume range of device 230, etc.

In some examples, dispense request 240, cancel chamber request 242, and chamber designation request 244 may be acquired from display 250 coupled to device 200 displaying, for example, GUI. In other examples, dispense request 240, cancel chamber request 242, and chamber designation request 244 may be acquired from a remote device via any communication protocol.

In examples, dispense engine 220 may control fluid dispense device 230 to cancel dispensing of a compound from a chamber. For example, dispense engine 220 may control fluid dispense device 230 to cancel dispensing of a second compound in chamber 235b. In such an example, chamber designation request 244 may identify chamber 235c as housing the second compound. In such an example, dispense engine 220 may control fluid dispense device 230 to dispense at least a portion of the first compound from chamber 235a and at least a portion of the second compound from chamber 235c according to a dispense routine. In examples, dispense engine 220 may be coupled to fluid dispense device 230 to dispense fluid into well plate 50. In examples, well plate 50 may be coupled to a transportation mechanism to move or transport well plate 50 such that a specific well may receive a compound from at least one of chamber 235a, chamber 235b, and chamber 235c. In other examples, well plate 50 may remain stationary and fluid dispense device 200 or a portion thereof, such as at least one of chamber 235a, chamber 235b, and chamber 235c, may travel or be transported such that a specific well may receive a compound from fluid dispense device 230. In yet further examples, both well plate 50 and fluid dispense device 230 may travel or move to allow a well in well plate 50 to receive a compound from fluid dispense device 230.

In examples, fluid dispense device 230 may include a fluid die with nozzles formed therein and an ejection chamber. In examples, nozzles may facilitate ejection/dispensation of a compound. Fluid dispense device 230 may comprise fluid actuators disposed proximate to the nozzles to cause drops of compound(s) to be ejected/dispensed from a nozzle orifice. In some examples, dispense engine 220 may generate a control pulse to electrically actuate the fluid actuator of fluid dispense device 230 to thereby dispense the compound(s). Some examples of types of fluid ejectors implemented in fluid dispense devices include thermal ejectors, piezoelectric ejectors, pressure pulse ejectors, acoustic ejectors, syringes, pin transfer tools and/or other such ejectors that may cause compound to eject/be dispensed from a nozzle. In some examples, at least one of chamber 235a, chamber 235b, and chamber 235c of fluid dispense device 230 may be removable. For example, at least one of chamber 235a, chamber 235b, and chamber 235c may be part of a component of fluid dispense device 230 which may be removed, such as a pipette or a cassette. In one such example, the fluid die, nozzle, and ejection chamber of fluid dispense device 230 may be removable from the fluid dispense device. In examples, fluid dispense devices may be able to dispense volumes from approximately 2 pL to approximately 200 μL. In such an example, the fluid dispense devices may dispense or eject a drop with a drop volume between approximately 2 pL and approximately 300 pL per drop.

While the example of FIG. 2 illustrates a fluid dispense device 230 with at least three chambers, other examples may include more or less chambers. In some examples, a fluid dispense device may comprise less chambers—i.e., one or two chambers. In other examples, a fluid dispense device may include more than three chambers, such as four chambers, five chambers, and/or other such configurations. Accordingly, example fluid dispense devices and devices with which such fluid dispense devices may couple may include sets of chambers based at least in part on application parameters.

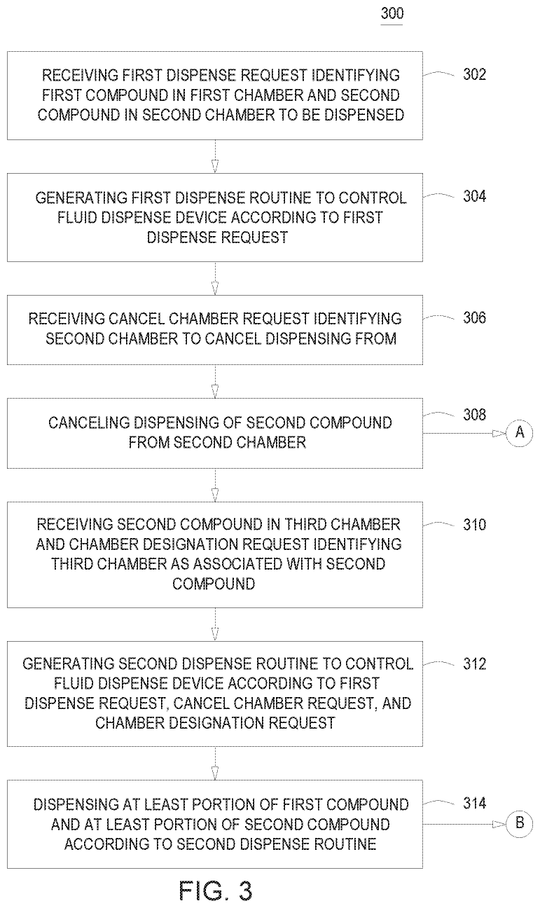

Turning to FIG. 3, this figure provides a flowchart 300 that illustrates a sequence of operations corresponding to a process to dispense a compound. As shown in 3, with a processor, a first dispense request identifying a first compound in a first chamber and a second compound in a second chamber to be dispensed is received at block 302. For example, referring to FIG. 2, the first compound may be in chamber 235a and the second compound may be in chamber 235b of fluid dispense device 230.

At 304, a first dispense routine to control a fluid dispense device is generated according to the first dispense request. In the example of FIG. 2, the dispense routine may identify chamber 235a and chamber 235b from which to dispense. In examples, the dispense routine may identify a number of drops of the first compound and the second compound to eject/dispense from chamber 235a and chamber 235b, respectively into well(s) of a well plate.

At 306, a cancel chamber request is received identifying the second chamber to cancel dispensing from. For example, referring again to FIG. 2, cancel chamber request 242 may identify chamber 235b to cancel dispensing from.

At 308, dispensing of a second compound from a second chamber is canceled. For example, referring again to FIG. 2, dispensing a compound from chamber 235b may be canceled.

At 310, the second compound is received in a third chamber and a chamber designation request identifying the third chamber as associated with the second compound is received. For example, referring to FIG. 2, a compound may be received in chamber 235c. In such an example, a chamber designation request 244 may be received identifying chamber 235c as the replacement compound for chamber 235b. In such an example, device 200 may prompt a user to fill chamber 235c with a replacement compound for chamber 235b via a GUI displayed on display 250. In some examples, chamber designation request 244 may be generated via the GUI. In other examples, chamber designation request 244 may be received from a remote device via any communication protocol.

At 312, a second dispense routine to control a fluid dispense device is generated according to the first dispense request, the cancel chamber request, and the third chamber. For example, referring to FIG. 2, dispense routine engine 210 may determine the second dispense routine according to dispense request 240, cancel chamber request 242, and chamber designation request 244.

At 314, at least a portion of the first compound and at least a portion of the second compound are dispensed according to the second dispense routine. For example, referring to FIG. 2, at least a portion of a compound in chamber 235a and at least a portion of compound in chamber 235c may be dispensed according to a second dispense routine generated by dispense routine engine 220. In examples, dispensing at least a portion of the first compound and at least a portion of the second compound comprises generating a control pulse to electrically actuate a fluid actuator of the fluid dispense device to thereby dispense the first dilution.

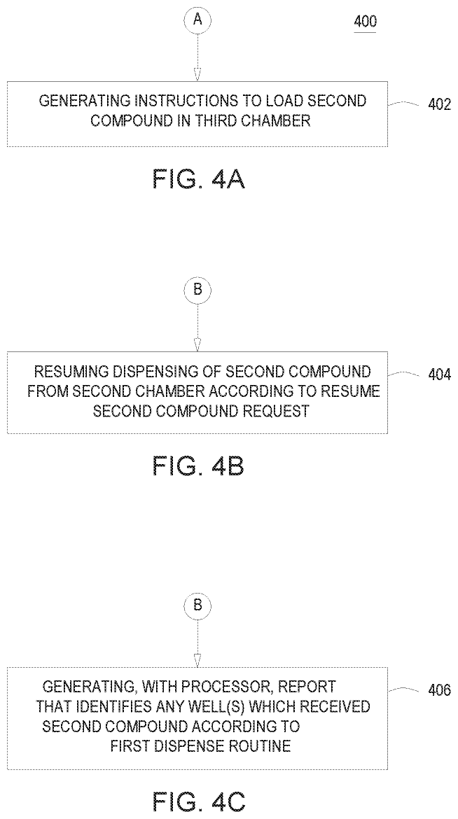

Turning now to FIGS. 4A, 4B, & 4C are flowcharts of example processes 400 which may be incorporated into the flowchart of FIG. 3.

At 402, generating via a GUI instructions to load the second compound in the third chamber. For example, referring to FIG. 2, device 200 may prompt a user to fill chamber 235c with a replacement compound for chamber 235b via a GUI displayed on display 250. In some examples, chamber designation request 244 may be generated via the GUI. In other examples, chamber designation request 244 may be received from a remote device via any communication protocol.

At 404, resuming dispensing of the second compound from the second chamber according to a resume chamber request. In examples, a resume chamber request may identify a chamber from which to resume dispensing after a cancel chamber request. For example, referring to FIG. 2, device 200 receive a resume chamber request to dispensing from chamber 235b. In some examples, a resume chamber request may be generated to purge the compound from chamber 235b.

At 406, generating with a processor, a report that identifies any well(s) which received the second compound from the second chamber according to the first dispense routine. In examples, the report may identify any well of a well plate into which the second compound was dispensed from the second chamber. In such examples, a user may be able to quickly identify any wells containing suspect data from the report. In some examples, the report may be displayed on a display coupled to the device 200 via a GUI.

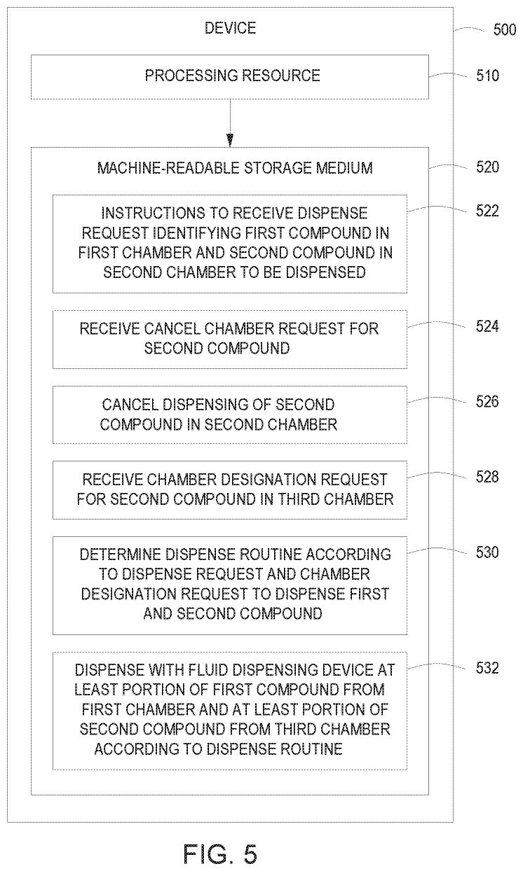

Turning now to FIG. 5, FIG. 5 is a block diagram of an example device 500 to dispense a fluid. In the example of FIG. 5, device 500 includes a processing resource 510 and a machine-readable storage medium 520 comprising (e.g., encoded with) instructions 522, 524, 526, 528, 530, and 532 executable by processing resource 510. In some examples, storage medium 520 may include additional instructions. In some examples, instructions 522, 524, 526, 528, 530, and 532 any other instructions described herein in relation to storage medium 520, may be stored on a machine-readable storage medium remote from but accessible to device 500 and processing resource 510 (e.g., via a computer network). In some examples, instructions 522, 524, 526, 528, 530, and 532 may be instructions of a computer program, computer application (“app”), agent, or the like, of device 500. In other examples, the functionalities described herein in relation to instructions 522, 524, 526, 528, 530, and 532 may be implemented as engines comprising any combination of hardware and programming to implement the functionalities of the engines, as described above.

In the example of FIG. 5, instruction 522 may receive a dispense request identifying a first compound in a first chamber and a second compound in a second chamber to be dispensed.

In instructions 524, device 500 receive a cancel chamber request for the second compound. In some examples, a cancel chamber request may be generated via a GUI. In other examples, the cancel chamber request may be received from a remote device via any communication protocol.

In instruction 526, cancel dispensing of the second compound in the second chamber.

In instruction 528, receive chamber designation request for the second compound in a third chamber. In some examples, a chamber designation request may be generated via a GUI. In other examples, the chamber designation request may be received from a remote device via any communication protocol.

In instruction 530, device 500 determines a dispense routine according to the dispense request and the chamber designation request to dispense the first compound and the second compound.

In instruction 532, dispense with a fluid dispensing device at least a portion of the first compound from the first chamber and at least a portion of the second compound from the third chamber according to the dispense routine. In examples, to dispense with a fluid dispensing device comprises generating a control pulse to electrically actuate a fluid actuator of the fluid dispense device to thereby dispense the first compound and the second compound.

In some examples, instructions 522, 524, 526, 528, 530 and 532 may be part of an installation package that, when installed, may be executed by processing resource 510 to implement the functionalities described herein in relation to instructions 522, 524, 526, 528, 530 and 532. In such examples, storage medium 520 may be a portable medium, such as a CD, DVD, flash drive, or a memory maintained by an imaging device from which the installation package can be downloaded and installed. In other examples, instructions 522, 524, 526, 528, 530 and 532 may be part of an application, applications, or component already installed on imaging device 500 including processing resource 510. In such examples, the storage medium 520 may include memory such as a hard drive, solid state drive, or the like. In some examples, the operations of the flowcharts of FIGS. 3-4C may be re-ordered, performed concurrently, or combined. In some examples, functionalities described herein in relation to FIG. 5 may be provided in combination with functionalities described herein in relation to any of FIGS. 1-4B. Similarly, any components of the devices shown in FIGS. 1, 2, and 5 may be removed, or combined with other components of other example devices.

What is claimed is:

1. A fluid dispense device, comprising:
a dispense routine engine to determine a first dispense routine for a first compound in a first chamber and a second compound in a second chamber, the dispense routine engine to determine a second dispense routine for the first compound and the second compound in response to a cancel chamber request for the second chamber and a chamber designation request for the second compound in a third chamber; and
a dispense engine to control the dispense device to cancel dispensing of the second compound from the second chamber and to dispense at least a portion of the first compound from the first chamber and at least a portion of the second compound from the third chamber according to the second dispense routine.

2. The device of claim 1, wherein the fluid dispense device is a fluid die with an ejection chamber.

3. The device of claim 1, wherein the chamber designation request identifies the third chamber as housing the second compound.

4. The device of claim 1, wherein the first chamber, the second chamber, and the third chamber are removable from the fluid dispense device.

5. The device of claim 1, wherein the cancel chamber request is received via a graphical user interface (GUI).

6. The device of claim 1, wherein the chamber designation request is received via a GUI.

7. The device of claim 1, wherein the dispense engine is to generate a control pulse to electrically actuate a fluid actuator of the fluid dispense device to thereby dispense the second dispense routine.

8. A method for dispensing, comprising:
receiving, with a processor, a first dispense request identifying a first compound in a first chamber and a second compound in a second chamber to be dispensed;
generating a first dispense routine to control a fluid dispense device according to the first dispense request;
receiving, with a processor, a cancel chamber request identifying the second chamber to cancel dispensing from;
canceling dispensing of the second compound from the second chamber;
receiving the second compound in a third chamber and, with a processor, a chamber designation request identifying the third chamber as associated with the second compound;
generating a second dispense routine to control a fluid dispense device according to the first dispense request, the cancel chamber request, and the chamber designation request; and
dispensing at least a portion of the first compound and at least a portion of the second compound according to the second dispense routine.

9. The method of claim 8, further comprising:
generating via a GUI instructions to load the second compound in the third chamber.

10. The method of claim 8, further comprising:
generating, with a processor, a report that identifies any well(s) which received the second compound according to the first dispense routine.

11. The method of claim 8, wherein the dispensing at least a portion of the first compound and at least a portion of the second compound comprises generating a control pulse to electrically actuate a fluid actuator of the fluid dispense device to thereby dispense the first dilution.

12. The method of claim 8, further comprising:
resuming dispensing of the second compound from the second chamber according to a resume second compound request.

13. A non-transitory machine-readable storage medium comprising instructions executable by a processing resource to:
receive a dispense request identifying a first compound in a first chamber and a second compound in a second chamber to be dispensed;
receive a cancel chamber request for the second compound;
cancel dispensing of the second compound in the second chamber;
receive chamber designation request for the second compound in a third chamber;
determine a dispense routine according to the dispense request and the chamber designation request to dispense the first compound and the second compound; and
dispense with a fluid dispensing device at least a portion of the first compound from the first chamber and at least a portion of the second compound from the third chamber according to the dispense routine.

14. The medium of claim 13, wherein the instructions to dispense with a fluid dispensing device comprises instructions to generate a control pulse to electrically actuate a fluid actuator of the fluid dispense device to thereby dispense the first compound and the second compound.

15. The medium of claim 13, wherein the chamber designation request identifies the third chamber as housing the second compound.
